(19) United States
(12) Patent Application Publication
(10) Pub. No.: US 2018/0133629 A1
(43) Pub. Date: May 17, 2018

(54) FILTRATING MODULE, FILTRATING DEVICE, AND FILTRATING METHOD

(71) Applicants: CHU-YI YANG, TAOYUAN CITY (TW); WAN-CHIEN YANG, TAOYUAN CITY (TW); MIN-LI YANG, TAOYUAN CITY (TW); SHEN-HAN YANG, TAOYUAN CITY (TW)

(72) Inventors: CHU-YI YANG, TAOYUAN CITY (TW); WAN-CHIEN YANG, TAOYUAN CITY (TW); MIN-LI YANG, TAOYUAN CITY (TW); SHEN-HAN YANG, TAOYUAN CITY (TW)

(21) Appl. No.: 15/793,335

(22) Filed: Oct. 25, 2017

(30) Foreign Application Priority Data
Nov. 16, 2016 (TW) 105137466

(51) Int. Cl. B01D 35/027; B01D 61/20; B05B 1/02; B01D 35/26

(52) U.S. Cl. CPC B01D 35/027; B01D 61/20; F02M 2037/225; B01D 35/26; B05B 1/02

(57) ABSTRACT

A filtrating module has a reservoir and a plurality of nozzles. The reservoir has an inlet opening, an outlet opening, a plurality of partitions, and a plurality of chambers. The chambers are respectively formed between each two adjacent ones of the partitions. Lower parts of the chambers communicate with each other but upper parts of the chambers are isolated from each other. The nozzles are respectively mounted under the inlet opening of the reservoir and in the upper parts of the chambers. Openings of the nozzles face downward and are inclined toward the next chamber, but the nozzle in the last chamber is inclined toward the outlet opening. A filtrating device includes the filtrating modules connected to each other. Therefore, the working fluid can be jetted downward and inclined to the liquid level of the working fluid, and thus contaminants in air can be dissolved in the working fluid.

### CROSS-REFERENCE TO RELATED APPLICATIONS

This application is based upon and claims priority under 35 U.S.C. 119 from Taiwan Patent Application No. 105137466 filed on Nov. 16, 2016, which is hereby specifically incorporated herein by this reference thereto.

### BACKGROUND OF THE INVENTION

### 1. Field of the Invention

The present invention relates to a filtrating module, a filtrating device, and a filtrating method, especially to a filtrating module, a filtrating device, and a filtrating method for purifying air.

### 2. Description of the Prior Arts

Most conventional filtrating devices each comprises a drawing apparatus and a filter, and thereby the drawing apparatus draws air to pass through the filter, so that dust, particles, cotton, or dust mites in the air may be filtrated out. However, to filtrate particles or any other contaminant with small diameters, the filter should have higher pore density, otherwise the filter may be clogged by the contaminant and thus air is not able to pass through the filter.

Besides, the filter may not filtrate the air thoroughly, and smells and harmful chemical substances can pass through the filter easily. Therefore, many conventional filtrating devices break those smell molecules by ozone, photocatalysts, negative ions, or currents, but the cost of the filtrating device may be increased significantly. In addition, the cost is also high for using a filtrating device to filtrate a large space.

To overcome the shortcomings, the present invention provides a filtrating module, a filtrating device, and a filtrating method to mitigate or obviate the aforementioned problems.

### SUMMARY OF THE INVENTION

The main objective of the present invention is to provide a filtrating module, a filtrating device, and a filtrating method with lower cost in production and maintenance, and cost of consumables are also lower.

The filtrating module has a reservoir and a jetting apparatus. The reservoir comprises an inlet opening, an outlet opening, a plurality of partitions, and a plurality of chambers. The inlet opening is formed at one end of the reservoir. The outlet opening is formed at another end of the reservoir. The partitions are mounted between the inlet opening and the outlet opening. Each two adjacent ones of the partitions form one of the chambers. Each one of the chambers comprises a lower part and an upper part. The lower parts of the chambers communicate with each other, and thereby all of the chambers communicate with the inlet opening and the outlet opening. A top of each one of the upper parts is closed. The jetting apparatus comprises a plurality of nozzles and a piping. The nozzles respectively is mounted under the inlet opening of the reservoir and in the upper parts of the chambers. The nozzles each has an opening facing downward and is inclined toward the outlet opening. The piping comprises a first end and a second end and forms a plurality of branches on the first end. The nozzles mounted on the branches.

The filtrating device has a plurality of the aforesaid filtrating modules and at least one connecting tube. Each two adjacent ones of the filtrating modules are connected by one of the at least one connecting tube. One end of each one of the at least one connecting tube communicates with the outlet opening of one of the two adjacent ones of the filtrating modules. Another end of said connecting tube communicates with the inlet opening of the other one of the two adjacent ones of the filtrating modules.

The filtrating method including processes as follows a preparing process and a filtrating process. The preparing process includes providing a reservoir and a working fluid. The reservoir comprises an inlet opening, an outlet opening, and a plurality of partitions. The partitions are mounted between the inlet opening and the outlet opening. The chambers are respectively formed between each two adjacent ones of the partitions. The chambers communicate with each other, the inlet opening, and the outlet opening by a lower part of each one of the chambers. The upper parts of the chambers isolated from each other. The working fluid is poured into the reservoir until lower edges of the partitions are under a liquid level of the working fluid. The filtrating process includes jetting the working fluid downward and toward the liquid level of the working fluid under the inlet opening, and toward lower openings of the chambers. The jetting directions of the working fluid are inclined toward the outlet opening. Thus, air is brought into the working fluid in the reservoir by the jetting working fluid near the inlet opening, then pushed by the jetting working fluid in the chambers, and finally discharged through the outlet opening.

With the filtrating module, the filtrating device, and the filtrating method, air can be completely mixed with the working fluid circulating in the reservoir, so consumables may not need replacing frequently. If the working fluid is water, the cost of the consumables is decreased significantly. In addition, structures of the filtrating modules are very simple and do not comprise a complex mechanism or circuit, so costs of production and maintenance are very low. Therefore, the present invention can be equipped on a trolley or a truck for vending purposes, and even if the trolley or vent is vibrated, the present invention still can keep working.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a filtrating module in accordance with a first embodiment of the present invention;

FIG. 2 is a sectional view of a first tank of a reservoir of the filtrating module in FIG. 1;

FIG. 3 is a sectional view of the reservoir of the filtrating module in FIG. 1;

FIG. 4 is a sectional view of the reservoir of the filtrating module in accordance with a second embodiment of the present invention;

FIG. 5 is a perspective view of the filtrating module in accordance with a third embodiment of the present invention;

FIG. 6 is a sectional view of a filtrating device in accordance with the present invention; and

FIG. 7 is a flow chat of a filtrating method in accordance with the present invention.

### DETAILED DESCRIPTION OF THE PREFERRED EMBODIMENTS

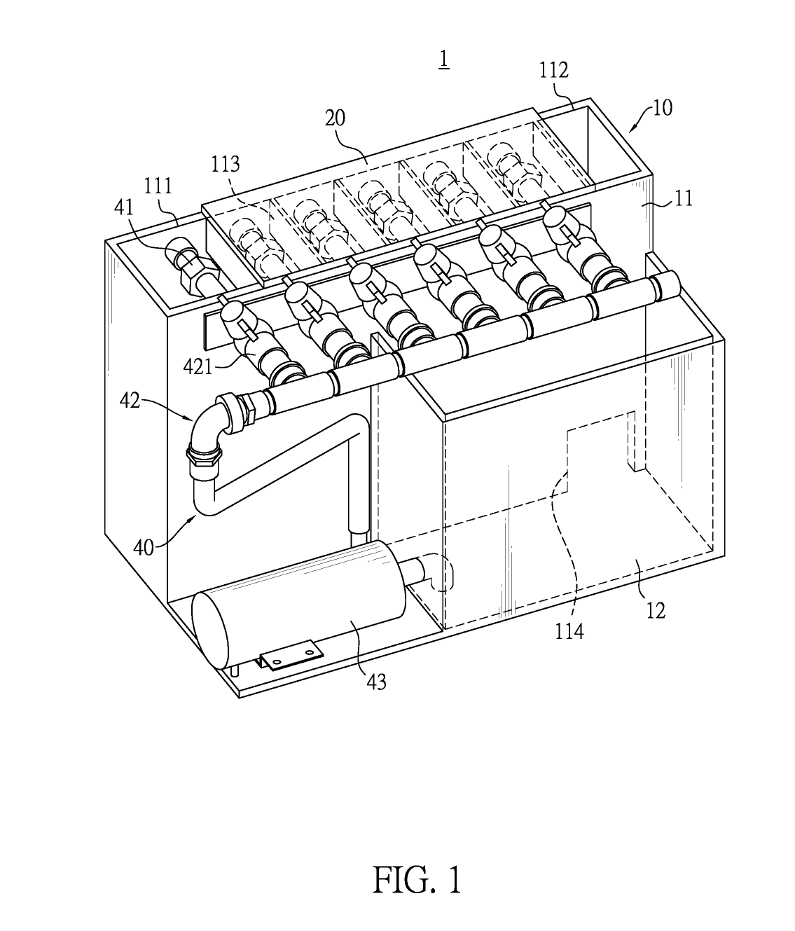

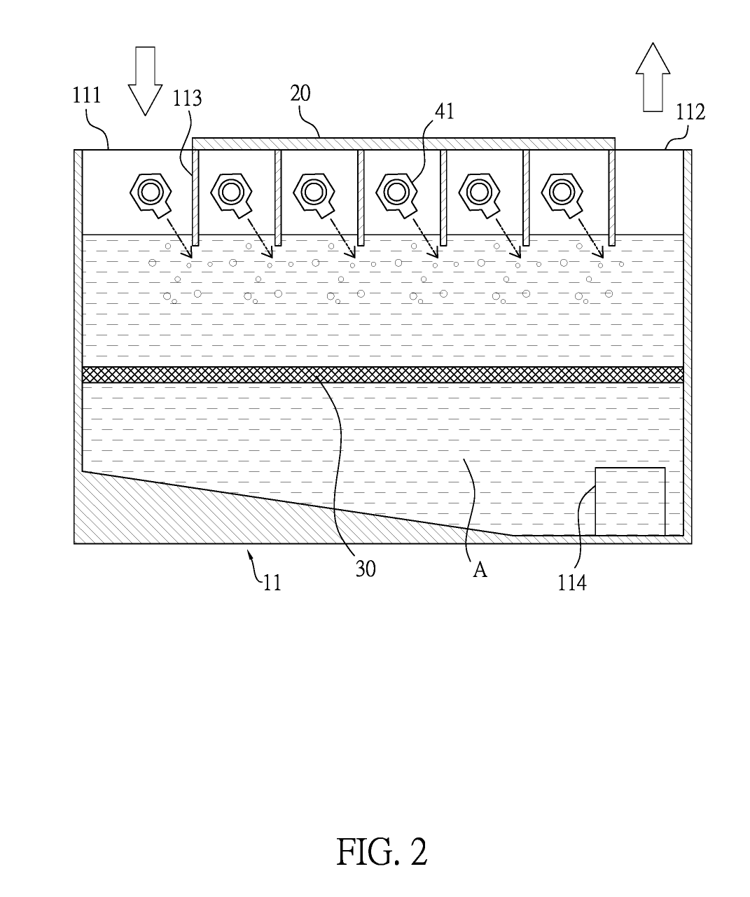

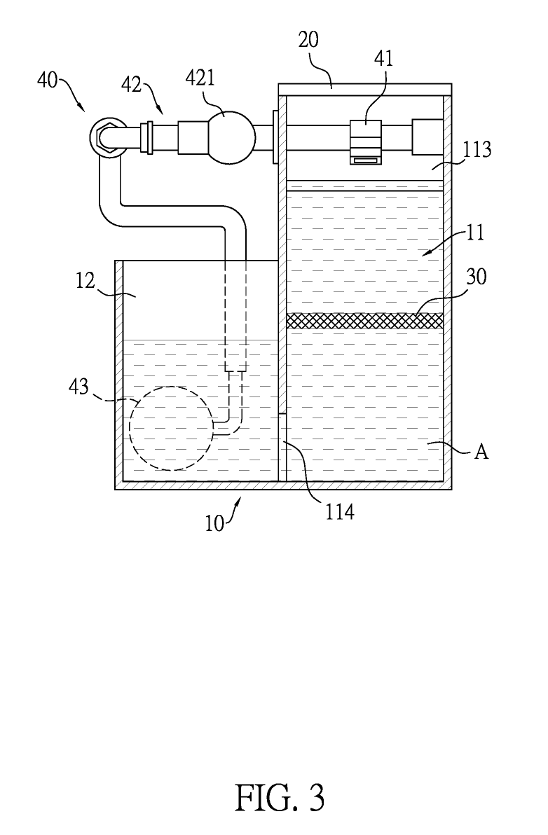

With reference to FIGS. 1 to 3, a filtrating module 1 in accordance with a first embodiment of the present invention comprises a reservoir 10, a lid 20, a filter 30, and a jetting apparatus 40.

The reservoir 10 forms a first tank 11 and a second tank 12. The first tank 11 comprises an inlet opening 111, an outlet opening 112, a plurality of partitions 113, and a plurality of chambers. The inlet opening 111 and the outlet opening 112 are located at two ends of the first tank 11. The partitions 113 are located between the inlet opening 111 and the outlet opening 112. Each one of the chambers is formed between two adjacent partitions 113. Each one of the chambers comprises a lower part, an upper part opposite the lower part, and an opening on the lower part so that the chambers communicate with each other through the openings of the lower parts. Furthermore, the lower part of each chamber communicates with the inlet opening 111 and the outlet opening 112. Tops of the upper parts of the chambers are closed, so the upper parts of the chambers are isolated from each other. In this embodiment, the lid 20 is securely mounted on the top of the reservoir 10, and is connected to and seal upper ends of the partitions 113. In other words, the chambers are sealed by the lid 20.

In this embodiment, an inner bottom surface of the first tank 11 of the reservoir 10 is an inclined surface, which is inclined toward one end of the first tank 11. However, in another embodiment, the inner bottom surface of the first tank 11 may include two inclined surfaces, which are inclined toward each other and thus forms a funnel.

A lower part of the second tank 12 communicates with a lower part of the first tank 11. Precisely, the first tank 11 forms a communicating opening 114 and thereby the first tank 11 and the second tank 12 communicate with each other via the communicating opening 114. The communicating opening 114 of the first tank 11 is formed adjacent to the inner bottom surface of the first tank 11 or is formed directly on the inner bottom surface of the first tank 11. In this embodiment, the communicating opening 114 is formed on a side surface of the first tank 11 and adjacent to the lowest portion of the inclined bottom surface.

The filter 30 is replaceable and removable, and is mounted in the first tank 11. Precisely, in this embodiment, the filter 30 is located between the chambers and the communicating opening 114, but it is not limited thereto; in another embodiment, the filter 30 may be mounted in the communicating opening 114 or in the second tank 12.

The jetting apparatus 40 comprises a plurality of nozzles 41, a piping 42, and a pump 43. The nozzles 41 are mounted respectively on the inlet opening 111 of the first tank 11 and in the upper parts of the chambers. Each nozzle 41 has an opening facing downward and inclined toward the outlet opening 112. In this embodiment, the inlet opening 111, the chambers and the outlet opening 112 are arranged in a line, so inclined directions of all the nozzles 41 are the same. In another embodiment, the inlet opening 111, the chambers, and the outlet opening 112 may be arranged annularly, in an L-shape, or in an S-shape, so that the inclined directions of the nozzles 41 are inclined toward the outlet opening 112 along the arranged path. In other words, the inclined directions of the nozzles 41 may be different.

The piping 42 comprises a first end, a second end, and a plurality of branches 421. The branches 421 are formed on the first end of the piping 42 and each one of the branches 421 is connected to a respective one of the nozzles 41. The second end of the piping 42 is connected to a lower part of the reservoir 10. Precisely, the piping 42 is connected to the lower part of the second tank 12 of the reservoir 10. The pump 43 is connected to the piping 42, and thereby the working fluid A in the second tank 12 is drawn by the pump 43, flows through the piping 42, and then is jetted into the first tank 11 from the nozzles 41.

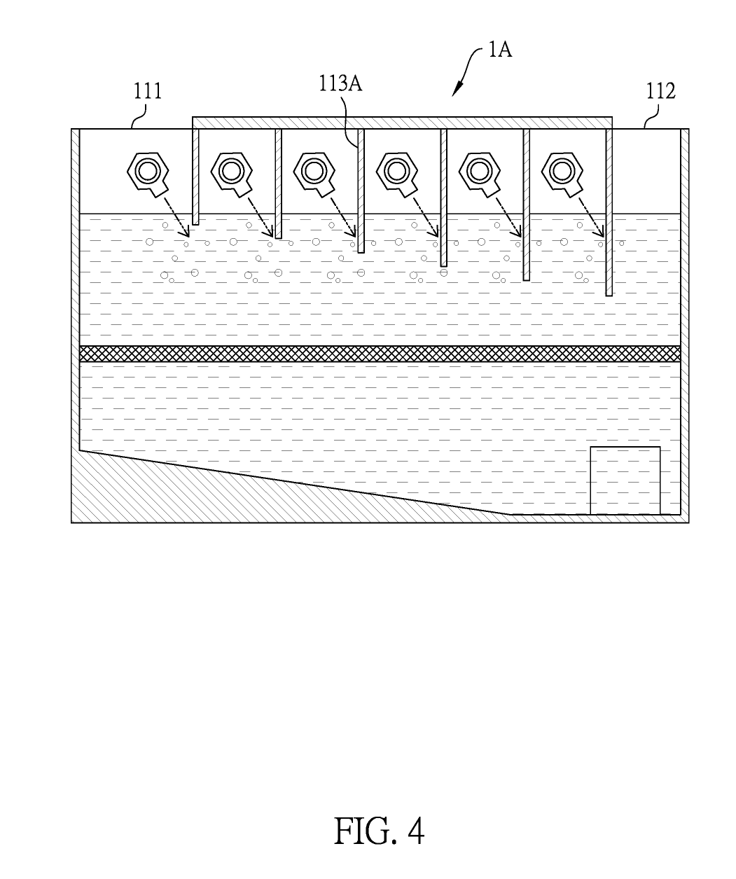

Then please refer to FIG. 4. In a second embodiment, technical features of the filtrating module 1A are similar to those of the first embodiment, but a difference is lower edges of partitions 113A progressively decrease in height in sequence from the inlet opening 111 to the outlet opening 112, rather than located at the same height.

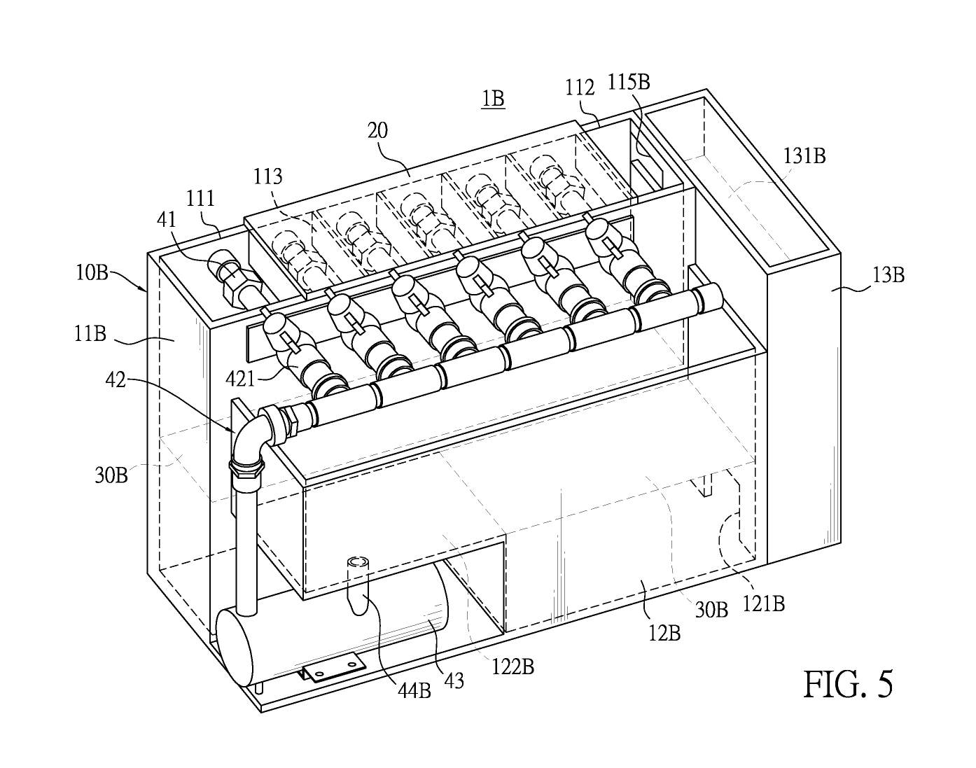

Then please refer to FIG. 5. In the third embodiment, technical features of the filtrating module 1B are similar to those of the first embodiment, but a difference is the first tank 11B of the reservoir 10B does not comprise a communicating opening for communicating with the second tank 12B of the reservoir 10B, and the reservoir 10B further comprises a third tank 13B. The third tank 13B communicates with both the first tank 11B and the second tank 12B. In this embodiment, the third tank 13B is mounted at the end of the first tank 11B, and said end forms the outlet opening 112. A surface of the first tank 11B forms an overflow opening 115B, and said surface is the surface that forms the outlet opening 112. The first tank 11B and the third tank 13B communicate with each other through the overflow opening 115B. A surface of the second tank 12B forms a backflow opening 121B. The second tank 12B and the third tank 13B communicate with each other through the backflow opening 121B. Precisely, the overflow opening 115B communicates with an upper part of the third tank 13B, and the backflow opening 121B communicates with a lower part of the third tank 13B. The third tank 13B comprises a filtrating component 131B, and the filtrating component 131B is located between the overflow opening 115B and the backflow opening 121B. The filtrating component 131B may be a filter or activated carbon, etc.

Another difference is that the second tank 12B comprises a stepped wall 122B and a space. The space is out of the second tank 12B and under the stepped wall 122B. The pump 43 is located in the space, i.e., the pump is out of the second tank 12B and under the stepped wall 122B. Therefore, a capacity of the reservoir 10B is increased. Besides, in this embodiment, the pump 43 communicates with the second tank 12B by another piping 44B which is mounted through the stepped wall 122B.

Another difference is that the reservoir 10B comprises two filters 30B. The filters 30B are removably mounted in the first tank 11B and the second tank 12B respectively. Precisely, one of the filters 30B is mounted under the chambers of the first tank 11B; the other filter 30B is mounted between the backflow opening 121B of the second tank 12B and the pump 43, and said filter 30B is parallel to the stepped wall 122B of the second tank 12B.

When the filtrating module 1B of the third embodiment is utilized, not only a lower edge of each one of the partitions 113 is below a liquid level of the working fluid A, but also a lower edge of the overflow opening 115B is below the liquid level, so the working fluid A may continuously flow into the third tank 13B from the overflow opening 115B. Then, after filtrated by the filtrating component 131B, the working fluid A flows into the second tank 12B from the backflow opening 121B. Thus, the working fluid A may be cleaned during the circulation.

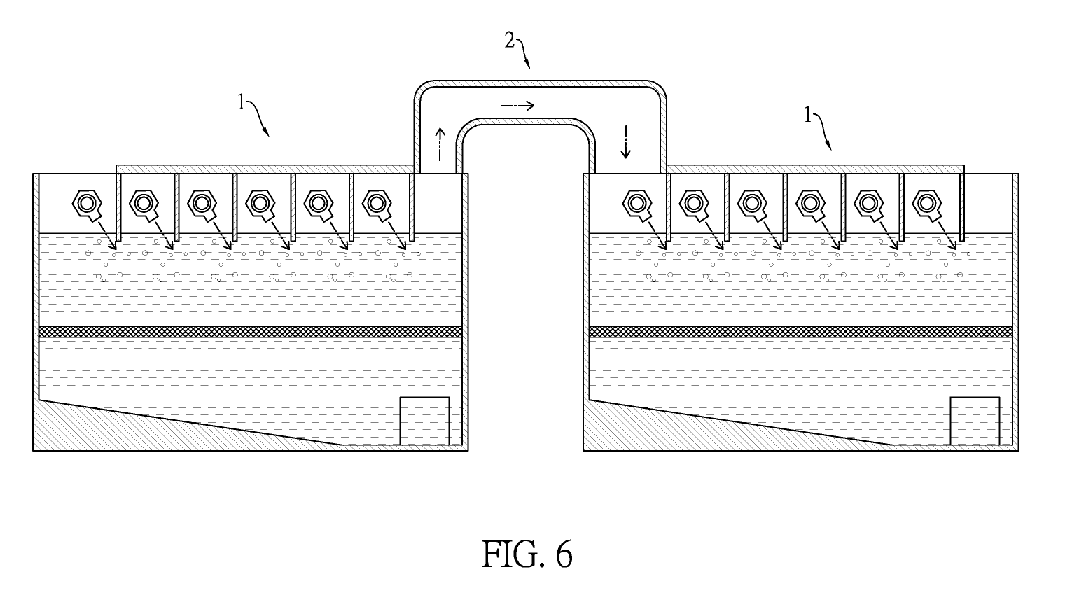

The filtrating modules 1, 1A, and 1B of the present invention can be used alone, or be mounted on wheels or a trolley for moving easily. Besides, a plurality of the filtrating modules 1, 1A, and 1B can be connected in series and used together. Precisely, please refer to FIG. 6, a filtrating device is provided and comprises a plurality of the aforesaid filtrating modules 1 and at least one connecting tube 2. Each two adjacent ones of the filtrating modules 1 are connected by one connecting tube 2. One end of the connecting tube 2 is sealed and communicates with the outlet opening 112 of one of the filtrating modules 1, and another end of the connecting tube 2 is sealed and communicates with the inlet opening 111 of another one of the filtrating modules 1. Therefore, to clean an area with dirtier air, a plurality of the aforesaid filtrating modules 1 can be connected in series, and thus effects of the filtrating modules 1 may be accumulated and enhanced to clean the dirtier air. Precisely, each two adjacent ones of the filtrating modules 1 are connected by one of the at least one connecting tube 2.

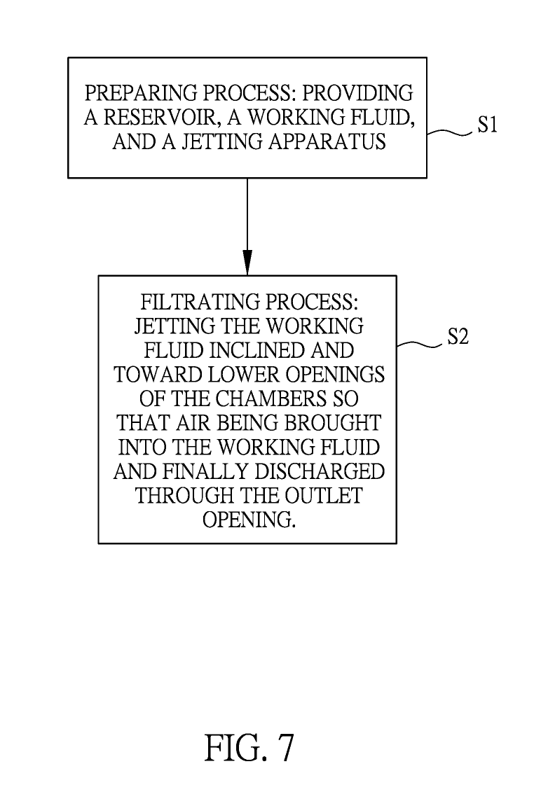

With reference to FIG. 7, a filtrating method is provided. The filtrating method includes a preparing process S1 and a filtrating process S2.

First, in the preparing process S1, a reservoir 10 and a working fluid A are provided. The reservoir 10, which may be similar to the reservoir 10, 10A, or 10B of the aforesaid filtrating module 1, 1A, or 1B, comprises an inlet opening 111, an outlet opening 112, a plurality of partitions 113, and a plurality of chambers. The partitions 113 are located between the inlet opening 111 and the outlet opening 112, and each one of the chambers is formed between two adjacent ones of the partitions 113. A lower part of each one of the chambers forms an opening so that the chambers communicate with each other. Furthermore, the lower part of each chamber communicates with the inlet opening 111 and the outlet opening 112. Upper parts of the chambers are isolated from each other. In the preparing process S1, the working fluid A is poured into the reservoir 10 until lower edges of the partitions 113 are under the liquid level of the working fluid A. The working fluid A may be water.

In this embodiment, to facilitate the continued filtrating process S2, in the preparing process S1, a jetting apparatus 40 is provided. The jetting apparatus 40, which may be similar to the aforesaid jetting apparatus 40, comprises a plurality of nozzles 41, a piping 42, and a pump 43. The nozzles 41 are respectively mounted in the upper parts of the chambers and the inlet opening 111 of the reservoir 10. The pump 43 communicates with the reservoir 10 through the piping 42, and thereby the working fluid A can be drawn from the reservoir 10 and pressed, pass through the piping 42, and be jetted from the nozzles 41 and back to the reservoir 10. Thus, the working fluid A is circulated by the jetting apparatus 40, and jetted from the nozzles 41 during the filtrating process S2. In addition, each one of the nozzles 41 has an opening facing downward and inclined toward the outlet opening 112.

In the filtrating process S2, the jetted working fluid A forms a plurality of liquid columns. The liquid columns are jetted toward the liquid level of the working fluid A from the inlet opening 111 or the upper part of the chambers, and jetting directions are inclined toward the outlet opening 112 in an arranging path of the inlet opening 111, the chambers, and the outlet opening 112. Thus, air around the inlet opening 111 may be brought into the reservoir 10 by the jetting working fluid A and then forms bubbles. Because the jetting direction is inclined and downward, the bubbles may run inclined and downward and move into the depth of the reservoir 10. However, because of buoyancies of the bubbles themselves and resistances of moving in the working fluid A, momentums of the bubbles are dismissed, such that most of the bubbles can only move to a position under the chamber which is nearest the inlet opening 111 and then float up and concentrate in the upper part of said chamber. In the contrary, part of the bubbles are small and thus the resistances on said bubbles are small as well, so said bubbles float up after running to one of the chambers located at relatively rear positions or running to the outlet opening 112.

The working fluid A is jetted inclined from the upper part of each chamber, so that air in the upper part of each chamber may be brought under the liquid level of the working fluid A and forms bubbles again. Because the jetting directions of the working fluid A are inclined toward the next chamber, the bubbles may float up at the next chamber. The movement repeats again and again so that air moves to the next chamber, which causes the air to transform bubbles and mix with the working fluid A repeatedly. Therefore, air passes through the reservoir 10 may contact the working fluid A thoroughly, and thereby contaminants contained in the air may dissolve in the working fluid A and the dirty air is cleaned. Besides, because all the nozzles 41 jet the working fluid A at the same time, some bubbles may not float up and transform back to the air, but follow the flow of the jetted working fluid A and move up and down until arriving at the outlet opening 112.

In another embodiment, to utilize and recycle the working fluid A, the reservoir 10 is provided with a filter 30. A location of the filter 30 is as described in the first embodiment, so that solid contaminants dissolved in the working fluid A can be filtrated. In still another embodiment, an inner bottom surface of the reservoir 10 is an inclined surface, so the solid contaminants may deposit at the lowest portion of the inner bottom surface. In this embodiment, a bottom surface of the reservoir 10 or somewhere near the bottom surface of the reservoir 10 may form a discharging opening or a communicating opening 114, and the filter 30 may be mounted in the discharging opening or the communicating opening 114, so that the solid contaminants can be discharged.

When the air moves through aforesaid process to the nearest chamber, which contains one nozzle 41 jetting the working fluid A, the air may be brought from the upper part of the last chamber into the liquid level and inclined toward the outlet opening 112, and thereby the cleaned air in the last chamber can be discharged from the outlet opening 112.

In another embodiment, the working fluid A may be supplied to the reservoir 10 by the nozzles 41 on one side and flow out from another side. In other words, the working fluid A does not circulate. Therefore, air is mixed with the pure working fluid A and is cleaned thoroughly.

Consequently, with the filtrating module 1, 1A, or 1B, the filtrating device, and the filtrating method, air can be completely mixed with the working fluid A circulating in the reservoir 10, so consumables may not be replaced frequently. Besides, if the working fluid A is water, the cost of the consumables is decreased significantly. In addition, structures of the filtrating modules 1, 1A, and 1B are very simple and do not comprise a complex mechanism or circuit, so costs of production and maintenance are very low. Therefore, the present invention can be equipped on a trolley or a truck for vending purposes and even if the trolley or vent is vibrated, the present invention still can keep working, which makes the present invention capable of preventing smell generated by a food vendor from spreading.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A filtrating module comprising:
a reservoir comprising:
an inlet opening formed at one end of the reservoir;
an outlet opening formed at another end of the reservoir;
a plurality of partitions mounted between the inlet opening and the outlet opening; and
a plurality of chambers, each two adjacent ones of the partitions forming one of the chambers; each one of the chambers comprising:
a lower part, the lower parts of the chambers communicating with each other, and thereby all of the chambers communicating with the inlet opening and the outlet opening; and
an upper part; a top of the upper part of each one of the chambers being closed; and
a jetting apparatus comprising:
a plurality of nozzles respectively mounted under the inlet opening of the reservoir and in the upper parts of the chambers; the nozzles each having an opening facing downward and inclined toward the outlet opening; and
a piping comprising a first end and a second end and forming:
a plurality of branches on the first end of the piping, the nozzles mounted on the branches.

2. The filtrating module as claimed in claim 1, wherein:
the jetting apparatus further comprises:
a pump connected to the piping; and
the second end of the piping is connected to a lower end of the reservoir.

3. The filtrating module as claimed in claim 2, wherein the reservoir forms:
a first tank, the inlet opening formed at one end of the first tank and the outlet opening formed at another end of the first tank; and
a second tank, a lower part of the second tank communicating with a lower part of the first tank, the second end of the piping connected to the lower part of the second tank.

4. The filtrating module as claimed in claim 2, wherein the reservoir forms:
a first tank, the inlet opening formed at one end of the first tank and the outlet opening formed at another end of the first tank;
a second tank, the second end of the piping connected to the second tank; and
a third tank, an upper part of the third tank communicating with the first tank and a lower part of the third tank communicating with the second tank.

5. The filtrating module as claimed in claim 1, wherein the filtrating module further comprises:
a filter removably mounted in the reservoir and mounted between the chambers and the pump.

6. The filtrating module as claimed in claim 3, wherein the filtrating module further comprises:
a filter removably mounted in the reservoir and mounted between the chambers and the pump.

7. The filtrating module as claimed in claim 4, wherein the filtrating module further comprises:
a filter removably mounted in the reservoir and mounted between the chambers and the pump.

8. The filtrating module as claimed in claim 1, wherein an inner bottom surface of the reservoir is an inclined surface.

9. The filtrating module as claimed in claim 6, wherein an inner bottom surface of the reservoir is an inclined surface.

10. The filtrating module as claimed in claim 7, wherein an inner bottom surface of the reservoir is an inclined surface.

11. The filtrating module as claimed in claim 1, wherein heights of lower edges of the partitions progressively degrease in sequence from the inlet opening to the outlet opening.

12. The filtrating module as claimed in claim 9, wherein heights of lower edges of the partitions progressively degrease in sequence from the inlet opening to the outlet opening.

13. The filtrating module as claimed in claim 10, wherein heights of lower edges of the partitions progressively degrease in sequence from the inlet opening to the outlet opening.

14. A filtrating device comprising:
a plurality of the filtrating modules as claimed in claim 1; and
at least one connecting tube, each two adjacent ones of the filtrating modules connected by one of the at least one connecting tube; one end of each one of the at least one connecting tube communicating with the outlet opening of one of the two adjacent ones of the filtrating modules, another end of said connecting tube communicating with the inlet opening of the other one of the two adjacent ones of the filtrating modules.

15. A filtrating method including processes as follows:
a preparing process including:
providing a reservoir, the reservoir comprising:
an inlet opening;
an outlet opening;
a plurality of partitions mounted between the inlet opening and the outlet opening; and
a plurality of chambers respectively formed between each two adjacent ones of the partitions; the chambers communicating with each other, the inlet opening, and the outlet opening by a lower part of each one of the chambers; upper parts of the chambers isolated from each other; and then providing a working fluid and pouring the working fluid into the reservoir until lower edges of the partitions are under a liquid level of the working fluid; and
a filtrating process including:
jetting the working fluid downward and toward the liquid level of the working fluid under the inlet opening, and toward lower openings of the chambers; jetting directions of the working fluid being inclined toward the outlet opening; thus, air being brought into the working fluid in the reservoir by the jetting working fluid near the inlet opening, then pushed by the jetting working fluid in the chambers, and finally discharged through the outlet opening.

16. The filtrating method as claimed in claim 15, wherein:
the preparing process further includes providing:
a jetting apparatus comprising:
a pump communicating with the reservoir;
in the filtrating process, the working fluid in the reservoir is drawn by the pump, and then jetted into the reservoir.
